(19) United States
(12) Patent Application Publication
(10) Pub. No.: US 2002/0182037 A1
(43) Pub. Date: Dec. 5, 2002

(54) Substrate processing apparatus, substrate processing system, and substrate conveying method

(75) Inventors: Shinyo Kimoto, Kyoto (JP); Kenji Tokunaga, Tokyo (JP); Seokhyun Kim, Seoul (KR); Terumi Muguruma, Kawasaki (JP); Yoshiaki Yamada, Hyogo (JP); Shinichi Watanabe, Ibaraki (JP); Masahiro Nishi, Tokyo (JP)

Correspondence Address: FOLEY AND LARDNER, SUITE 500, 3000 K STREET NW, WASHINGTON, DC, 20007, US

(73) Assignee: SEMICONDUCTOR LEADING EDGE TECHNOLOGIES, INC.

(21) Appl. No.: 10/091,588

(22) Filed: Mar. 7, 2002

(30) Foreign Application Priority Data
Mar. 9, 2001 (JP) 2001-066041

(51) Int. Cl. B65G 49/07

(52) U.S. Cl. 414/217; 414/217.1; 414/939; 414/940

(57) ABSTRACT

A substrate processing apparatus for providing predetermined processing to wafers brought in through the load port door comprises in the front of the load port door a load port table on which a wafer carrier accommodating a plurality of wafers is placed, and a shield plate is provided so as to surround the load port table.

### BACKGROUND OF THE INVENTION

1. Field of the Invention

The present invention relates to a substrate processing apparatus used by combining with a wafer carrier for accommodating and conveying substrates, a substrate processing system, and a method for conveying substrates.

2. Background Art

It is a general practice in recent processes for manufacturing semiconductors to use a wafer carrier (substrate accommodating jig) from the point of view of convenience in accommodating and conveying semiconductor substrates.

For example, an FOUP (front opening unified pod), which is specified in the SEMI Standards, is generally used as a wafer carrier for accommodating and conveying wafers having a diameter of 300 mm, which is becoming the main stream. Information about the detailed dimensions and the like is found in the SEMI Standards, E57, E1.9, or E47.1.

FIG. 2 is a schematic diagram for illustrating an automatic conveying method for a wafer carrier (FOUP 1) in the production site where a plurality of substrate processing apparatuses 2, and shows an automatic conveyer of an FOUP 1 using OHT (overhead Hoist transfer) 3.

In a semiconductor factory, wafers to be undergone various processing accommodated in an FOUP 1 are transferred between substrate processing apparatuses 2. Since the FOUP 1 accommodating a plurality of 300 mm-class wafers has a weight of 8 kg or more, it is difficult to transfer manually for safety reasons, and an automatic conveyer, such as OHT 3, is used.

The OHT 3 is a typical automatic conveyer of the FOUP 1 in the bay of a semiconductor factory. Each of a plurality of substrate processing apparatuses 2 installed in a line is provided with a load port table 2a, and is constituted so that an FOUP 1 conveyed from other substrate processing apparatuses 2 by the hoisting mechanism of the OHT 3 is placed on the load port table 2a.

Thus, in the substrate processing system wherein substrate processing apparatuses 2 are connected through OHT 3, since an FOUP 1 accommodating a plurality of substrates can be conveyed between apparatuses using OHT 3, the system can be operated efficiently.

However, since the FOUP 1 is conveyed at a relatively high level for example, over the head of the operator working in the factory for avoiding obstructs, there is a problem that if the FOUP 1 falls during conveying, the substrates in the FOUP 1 and members around the point where the FOUP 1 falls will be damaged.

Especially in conveying using OHT 3, since the OHT 3 holds the top flange 1a on the upper surface of the FOUP 1, there is a danger that the FOUP 1 falls if the top flange 1a is damaged during conveying.

If the FOUP 1 falls, there is danger that not only the accommodated wafers are damaged, but also the parts of the apparatus whereon the FOUP 1 falls. Normally, damage of the FOUP 1 or the parts of the apparatus can be reduced by providing a netlike cover under the rail of the OHT 3 between the substrate processing apparatuses 2. However, no netlike cover can be provided because the FOUP 1 must be conveyed in the substrate processing apparatuses 2. Therefore, if the top flange 1a is broken when the OHT 3 holding the top flange 1a is ascended or descended above the substrate processing apparatuses 2, or if the top flange 1a of the OHT 3 is removed from the mechanism that holds the top flange 1a, the damage of the FOUP 1 and the parts of the substrate processing apparatuses 2 cannot be avoided. Especially in these cases, since the point whereon the FOUP 1 falls is the load port table 2a for the delivery of the FOUP 1 provided on the substrate processing apparatuses 2, the FOUP 1 that has fallen collides against the load port table 2a and rebounds to surrounding members, or scatters to collide with surrounding members, these members or parts may be damaged. Also, the improvement of the safety of the operator working in the vicinity of the substrate processing apparatuses 2 must be considered.

Furthermore, when an operator manually feeds the FOUP 1 to or takes the FOUP 1 out of the substrate processing apparatuses 2 while the OHT 3 performs ascending or descending operations on the load port table 2a, the FOUP 1 fed by the OHT 3 may interfere with the FOUP 1 fed by the operator, causing hindrance to the operator's work.

### SUMMARY OF THE INVENTION

The present invention aims at the solution of the above-described problems, and the first object of the present invention is to minimize the damage of the members surrounding the substrate processing apparatus even if the wafer carrier falls down when it is moved, ascended, and descended above the substrate processing apparatus.

The second object of the present invention is to prevent the wafer carrier from hindering the operator to feed the wafer carrier to and take the wafer carrier out of the substrate processing apparatus when the wafer carrier is moved, ascended, and descended above the substrate processing apparatus.

According to one aspect of the present invention, there is provided a substrate processing apparatus for providing predetermined processing to substrates brought from a load port door. The apparatus comprises a load port table on which a wafer carrier that accommodates a plurality of the substrates at the front of the load port door, and a shield plate provided so as to surround the load port table.

According to another aspect of the present invention, a substrate processing system has a plurality of substrate processing apparatuses for providing predetermined processing to substrates brought from a load port door. The apparatuses are connected through conveyer means. Each of the substrate processing apparatuses comprises a load port table on which a wafer carrier that accommodates a plurality of the substrates at the front of the load port door, a shield plate provided so as to surround the load port table, and a door that can be opened or closed provided on the shield plate. The door of specified substrate processing apparatus is maintained in the closed state thereof at the time when the substrate processing apparatus to which the wafer carrier is conveyed is specified.

According to another aspect of the present invention, a substrate processing system has a plurality of substrate processing apparatuses for providing predetermined processing to substrates brought from a load port door. The apparatuses are connected through conveyer means. Each of the substrate processing apparatuses comprises a load port table on which a wafer carrier that accommodates a plurality of the substrates at the front of the load port door, a shield plate provided so as to surround the load port table, and a door that can be opened or closed provided on the shield plate. The door of specified substrate processing apparatus is maintained in the closed state thereof at the time when the wafer carrier conveyed by the conveyer means arrives above the load port table of the specified substrate processing apparatus.

According to another aspect of the present invention, a method for conveying substrates utilizing a substrate processing system wherein a plurality of substrate processing apparatuses comprising a load port table surrounded by a shield plate having a door that can be opened or closed, connected through conveyer means, and a wafer carrier that accommodates a plurality of substrates is ascended or descended to bring the wafer carrier to or out of the load port table of each substrate processing apparatus. The door is maintained in the closed state thereof when the wafer carrier is brought in or out of the load port table using the conveyer means.

According to another aspect of the present invention, since a shield plate is provided so as to surround the load port table, the falling or scattering of a wafer carrier can be prevented even if the wafer carrier is disconnected at the location above the load port table.

When a substrate processing apparatus in which a wafer carrier is brought is specified, since the above-described door of the substrate processing apparatus is kept closed, interference with the wafer carrier manually brought in can be inhibited.

Since the door is kept closed when the wafer carrier conveyed from the other processing apparatus arrives at the location above the load port table, the manual feeding of the other wafer carrier can be inhibited while the former wafer carrier is fed on the load port table.

When the wafer carrier is brought in or out of the load port table, since the lock mechanism is operated to keep the door closed, the interference of the wafer carrier conveyed by the conveyer means with the wafer carrier manually brought in or out can be inhibited.

### BRIEF DESCRIPTION OF THE DRAWINGS

FIG. 1 is a perspective view showing the constitution of a substrate processing system according to an embodiment of the present invention.

FIG. 2 is a schematic diagram for illustrating an automatic conveying method for a wafer carrier in the production site.

### DETAILED DESCRIPTION OF THE PREFERRED EMBODIMENTS

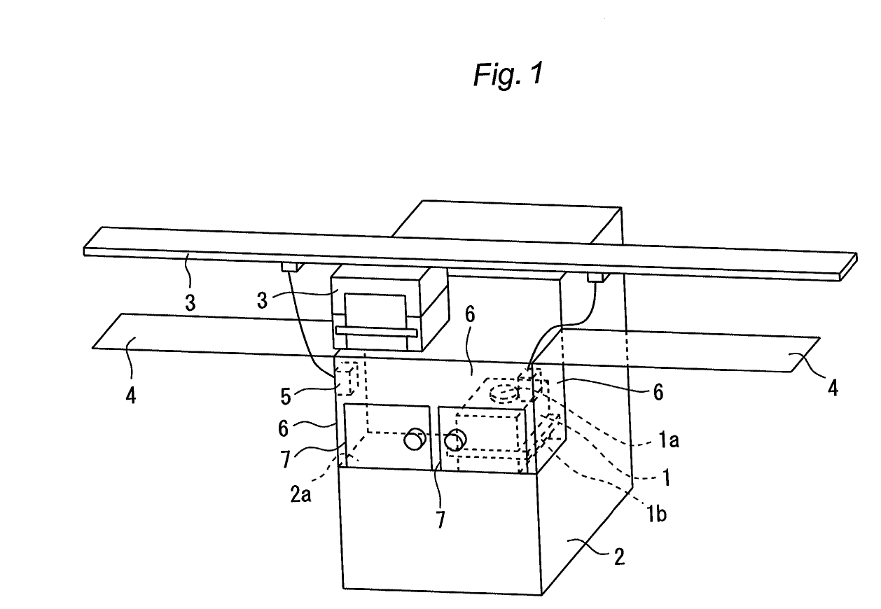

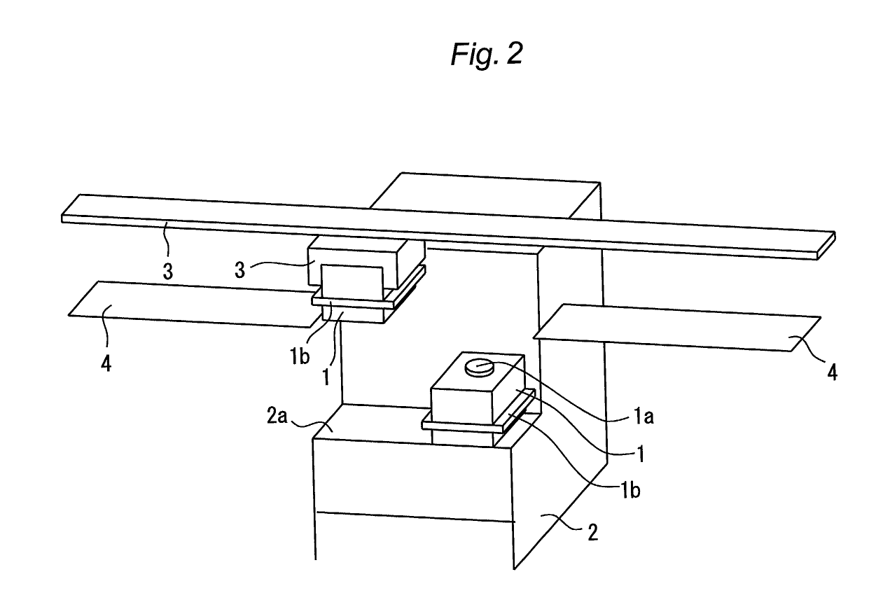

FIG. 1 is a perspective view showing the constitution of a substrate processing system according to an embodiment of the present invention. As FIG. 1 shows, a substrate processing apparatus 2, which is an apparatus for semiconductor manufacturing equipment, substrate cleaning equipment, is provided with a load port table 2a in the front thereof to once stop the FOUP 1 that has been conveyed, opens and closes the carrier door of the FOUP 1 and the load port door of the substrate processing apparatus 2, and brings wafers in and out of the substrate processing apparatus 2. The load port table 2a specified in the above-described SEMI Standards is a load port table having an FIMS surface. Here, FIMS is the abbreviation of the “front-opening interface mechanical standard.” In FIG. 1, the constituting components common to those in FIG. 2 are denominated by the same reference numerals and characters as in FIG. 2.

An OHT 3 (conveyer means) for conveying the FOUP 1 is installed above the load port table 2a. As described above, the OHT 3 is disposed so as to connect between substrate processing apparatuses 2. The FOUP 1 conveyed above the load port table 2a by the OHT 3 is descended to the load port table 2a by the hoisting mechanism of the OHT 3, and set on the predetermined position. The carrier door of the FOUP 1 and the load port door of the substrate processing apparatus 2 are opened, and a wafer is brought in or out of the substrate processing apparatus 2.

Immediately under the OHT 3 between the substrate processing apparatuses 2, first falling prevention cover 4 constituted from, for example, a netlike cover is disposed. The first falling prevention cover 4 plays a role to prevent the FOUP 1 to fall further downward when the FOUP 1 is removed from the OHT 3 between the substrate processing apparatuses 2.

On the front and the side of the load port table 2a, a second falling prevention cover (shield plate) 6 is provided upward up to the location immediately under the OHT 3. On the front of the second falling prevention cover 6, a front door 7 is provided. The second falling prevention cover 6 disposed on the side of the load port table 2a is connected to the first falling prevention cover 4 immediately under the OHT 3. In FIG. 1, since the rear side of the load port table 2a is a region for actually bringing wafers in and out through the load port door, by disposing the second falling prevention cover 6 on the front and the side of the load port table 2a, the load port table 2a is completely surrounded by the second falling prevention cover 6.

Thus, in the vicinity of the load port where the first falling prevention cover 4 is interrupted, by providing the second falling prevention cover 6 extending from the location above the load port table 2a to the location immediately under the OHT 3, the falling of the FOUP 1 to the floor is prevented by the first falling prevention cover 4 when the FOUP 1 is removed from the OHT 3 at a place between substrate processing apparatuses 2; and the falling of the FOUP 1 to the floor or the scattering of the FOUP 1 is prevented by the second falling prevention cover 6 when the FOUP 1 is removed from the OHT 3 at a place above the load port table 2a. Thus, it is possible to present damage of members and parts placed under the OHT 3 between the substrate processing apparatuses 2 and placed around the substrate processing apparatus 2. Also, the safety of operators working in the vicinity of the substrate processing apparatuses 2 can be improved. When the FOUP 1 is manually brought in or out of the load port table 2a without using the OHT 3, this can be performed by opening or closing the front door 7 provided on the second falling prevention cover 6.

Next, a method for bringing the FOUP 1 in and out of the load port table 2a synchronized with the open/close lock mechanism of the front door 7 will be described in detail. When the predetermined processing of a wafer in the substrate processing apparatus 2 has been completed, the completion of processing is reported from the substrate processing apparatus 2 to upper control device. The upper control device, when receiving the report, transmits the request to bring out the FOUP 1 to the OHT 3. The OHT 3, when receiving the request, checks whether the front door 7 of the second falling prevention cover 6 is open before starting the operation to bring out the FOUP 1. If the front door 7 is not open, the front door 7 is held closed by locking with the door lock device 5 before starting the operation to bring out the FOUP 1. When the operation to bring the FOUP 1 out of the load port table 2a is completed, the lock of the door lock device 5 of the front door 7 is released.

When the OHT 3 conveys the FOUP 1 to the location above the load port table 2a of the next substrate processing apparatus 2, the OHT 3 checks that the front door 7 of the second falling prevention cover 6 of the substrate processing apparatus 2 to which the FOUP 1 is brought is not open. After the front door 7 is held closed by locking with the door lock device 5 before starting the operation to bring out the FOUP 1, the FOUP 1 is descended toward the load port table 2a of the substrate processing apparatus 2 to which the FOUP 1 is brought. After the FOUP 1 is descended to the load port table 2a, the lock of the door lock device 5 of the front door 7 is released.

The above-described synchronization of the conveyance of the FOUP 1 with the open/close lock mechanism of the front door 7 is achieved by letting both the door lock device 5 of the front door 7 and the OHT 3 recognize mutual interlocking signals, so as to permit either manual or automatic operation to transfer the FOUP 1 to the load port table 2a, and by letting them transmit and receive the interlocking signals.

Thereby, the front door 7 can be locked when the FOUP 1 is brought in and out of the load port table 2a, and the prevention of the interference of the FOUP 1 manually brought in or out by an operator and the FOUP 1 automatically brought in or out by the OHT 3 can be ensured.

The front door 7 may also be locked before the FOUP 1 is brought above the load port table 2a of the next substrate processing apparatus 2. In other words, the manual feeding of the FOUP 1 can be prohibited by locking the front door 7 of a specified substrate processing apparatus 2 at a time when the upper control device specifies a substrate processing apparatus 2 as the next destination of delivery. Therefore, when the FOUP 1 is brought in or out of the substrate processing apparatus 2, the interference of the FOUP 1 conveyed by the OHT 3 and the FOUP 1 manually fed can be surely inhibited.

According to this embodiment, as described above, since the first falling prevention cover 4 is provided along the OHT 3, and the second falling prevention cover 6 is provided so as to surround the load port table 2a, the falling of the FOUP 1 can be prevented, the damage of members disposed under the OHT 3 or in the vicinity of the substrate processing apparatus 2 can be inhibited, and the safety of operators can be improved. Also, by synchronizing the location of the FOUP 1 conveyed by the OHT 3 and the open/close lock of the second falling prevention cover 6, the interference of the FOUP 1 being automatically conveyed with the FOUP 1 being manually fed or taken out by an operator can be prohibited.

Also, since the upper control device instructs the OHT 3 to convey the FOUP 1 to the substrate processing apparatus 2 of the next destination, and the front door 7 of the substrate processing apparatus 2 of the next destination is locked by the door lock device 5, the operator is not allowed to open the front door 7 to feed another FOUP 1 before the FOUP 1 to be conveyed is brought to the next substrate processing apparatus 2. Therefore, the interference of the FOUP 1 conveyed by the OHT 3 with the FOUP 1 manually fed by an operator can be avoided, and efficient conveying can be continued without disturbing the conveying schedule determined by the upper control device.

The OHT 3, when conveying the FOUP 1, may hold not only the top flange 1a of the FOUP 1, but also the side rail 1b at the same time in case the top flange 1a is damaged. Also in this embodiment, although a semiconductor substrate having a diameter of 300 mm is exemplified as a specific example of the semiconductor substrate to be inserted in the FOUP 1, and the processing apparatus and the processing system for a substrate having a diameter of 300 mm is shown, the present invention can also be applied to other substrates, such as glass substrates for liquid crystals.

Since the present invention is constituted as described above, the following effects can be achieved:

Since a shield plate is provided so as to surround the load port table, the falling or scattering of a wafer carrier can be prevented even if the wafer carrier is disconnected at the location above the load port table.

Since a wafer carrier can be ascended or descended by a conveyer means within a region surrounded by the shield plate, the wafer carrier can be surely brought in or out of the load port table.

When the wafer carrier is brought in or out of the load port table, since the lock mechanism is operated to keep the door closed, the interference of the wafer carrier conveyed by the conveyer means with the wafer carrier manually brought in or out can be inhibited.

Since the door is kept closed when the wafer carrier conveyed from the other processing apparatus arrives at the location above the load port table, the manual feeding of the other wafer carrier can be inhibited while the former wafer carrier is fed on the load port table.

Since a wafer carrier can be brought in or out manually through the door when the lock mechanism is not operated, the wafer carrier can be brought in not only automatically, but also manually as required.

When a substrate processing apparatus in which a wafer carrier is brought is specified, since the above-described door of the substrate processing apparatus is kept closed, interference with the wafer carrier manually brought in can be inhibited.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-66041, filed on Mar. 9, 2001 including specification, claims, drawings and summary, on which the Convention priority of the present application is based, are incorporated herein by reference in its entirety.

1. A substrate processing apparatus for providing predetermined processing to substrates brought from a load port door, comprising:
a load port table on which a wafer carrier that accommodates a plurality of said substrates at the front of said load port door, and
a shield plate provided so as to surround said load port table.

2. The substrate processing apparatus according to claim 1, wherein
said wafer carrier is brought in and out of said load port table by a conveyer means, and
said conveyer means brings said wafer carrier in and out of said load port table by ascending and descending said wafer carrier within a region surrounded by said shield plate.

3. The substrate processing apparatus according to claim 2, further comprising:
a door that can be opened or closed provided on said shield plate, and
a lock mechanism for holding said door in a closed state, wherein
said door is maintained in the closed state thereof by making said lock mechanism function when said wafer carrier is brought in and out of said load port table by said conveyer means.

4. The substrate processing apparatus according to claim 3, wherein
said door is maintained in the closed state thereof when said wafer carrier brought from another processing apparatus arrives above said load port table.

5. A substrate processing system having a plurality of substrate processing apparatuses for providing predetermined processing to substrates brought from a load port door, connected through conveyer means, wherein:
each of said substrate processing apparatuses comprises a load port table on which a wafer carrier that accommodates a plurality of said substrates at the front of said load port door, a shield plate provided so as to surround said load port table, and a door that can be opened or closed provided on said shield plate, and
said door of specified substrate processing apparatus is maintained in the closed state thereof at the time when said substrate processing apparatus to which said wafer carrier is conveyed is specified.

6. A substrate processing system having a plurality of substrate processing apparatuses for providing predetermined processing to substrates brought from a load port door, connected through conveyer means, wherein:
each of said substrate processing apparatuses comprises a load port table on which a wafer carrier that accommodates a plurality of said substrates at the front of said load port door, a shield plate provided so as to surround said load port table, and a door that can be opened or closed provided on said shield plate, and
said door of specified substrate processing apparatus is maintained in the closed state thereof at the time when said wafer carrier conveyed by said conveyer means arrives above said load port table of said specified substrate processing apparatus.

7. A method for conveying substrates utilizing a substrate processing system wherein a plurality of substrate processing apparatuses having a load port table surrounded by a shield plate comprising a door that can be opened or closed, connected through conveyer means, and a wafer carrier that accommodates a plurality of substrates is ascended or descended to bring said wafer carrier to or out of said load port table of each substrate processing apparatus, wherein:
said door is maintained in the closed state thereof when said wafer carrier is brought in or out of said load port table using said conveyer means.

8. The method for conveying substrates according to claim 7, wherein said door is maintained in the closed state thereof at the time when said substrate processing apparatus to which said wafer carrier is conveyed is specified.

9. The method for conveying substrates according to claim 7, wherein said door is maintained in the closed state thereof at the time when said wafer carrier conveyed by said conveyer means arrives above said load port table of specified substrate processing apparatus.
